(19) United States
(12) Patent Application Publication
(10) Pub. No.: US 2025/0246592 A1
(43) Pub. Date: Jul. 31, 2025

(54) METHOD OF MANUFACTURING ELECTRODE BODY AND METHOD FOR MANUFACTURING POWER STORAGE DEVICE

(71) Applicant: TOYOTA JIDOSHA KABUSHIKI KAISHA, Toyota-shi (JP)

(72) Inventors: Masato Ono, Nagoya-shi (JP); Tomoya Mesuda, Nisshin-shi (JP); Yosuke Shimura, Nagakute-shi (JP)

(73) Assignee: TOYOTA JIDOSHA KABUSHIKI KAISHA, Toyota-shi (JP)

(21) Appl. No.: 18/919,439

(22) Filed: Oct. 18, 2024

(30) Foreign Application Priority Data
Jan. 26, 2024 (JP) 2024-010456

(51) Int. Cl. H01M 4/04; H01M 4/02; H01M 4/62; H01M 4/66

(52) U.S. Cl. CPC H01M 4/0404; H01M 4/621; H01M 2004/021; H01M 4/661; H01M 4/663; H01M 4/667; H01M 2220/20

(57) ABSTRACT

In a method of manufacturing an electrode body, a slurry is applied on an electrode current collector, and a coating layer is formed so that an uncoated region is formed. The coating layer is dried to form an active material layer. At least one condition selected from the group consisting of: a first slurry applied to a central region of the coating layer; a second slurry applied to an end region adjacent to the non-coated region at the periphery of the central region; and (A) a second slurry having a lower NV than the first slurry; (B) a tap-density of an active material in which the second slurry is included than the first slurry; (C) a second slurry having a lower binder content than the first slurry; and (D) a glass transition temperature of a binder in which the second slurry is included than the first slurry.

### CROSS-REFERENCE TO RELATED APPLICATION

This application claims priority to Japanese Patent Application No. 2024-010456 filed on Jan. 26, 2024, incorporated herein by reference in its entirety.

### BACKGROUND

### 1. Technical Field

The present disclosure relates to a method for manufacturing an electrode body and a method for manufacturing a power storage device.

### 2. Description of Related Art

Hitherto, there is a method for manufacturing an electrode body in which an active material layer is formed on an electrode current collector by applying a slurry containing a binder, an active material, and a solvent to the electrode current collector to form a coating layer and then drying the coating layer.

For example, Japanese Unexamined Patent Application Publication No. 06-063495 (JP 06-063495 A) discloses a coating film drying method in which a coating film is irradiated with far-infrared rays having a wavelength with high absorptivity for an organic solvent and the organic solvent is evaporated from the entire layer of the coating film to bring the coating film into a dry state.

### SUMMARY

When laser irradiation is applied to drying of the coating layer for forming the active material layer, cracks may be generated at the end of the formed active material layer.

The present disclosure has been made in view of the above circumstances, and an object thereof is to provide a method for manufacturing an electrode body and a method for manufacturing a power storage device in which generation of cracks at the end of a formed active material layer is suppressed.

Means for addressing the above issue includes the following aspects.
<1> A method for manufacturing an electrode body includes:
applying a slurry containing a binder, an active material, and a solvent to an electrode current collector to form a coating layer and to form an uncoated region where the slurry is not applied on a periphery of the coating layer; and
drying the coating layer by irradiating the coating layer with a laser to form an active material layer.

In the applying, a first slurry applied to a central region of the coating layer and a second slurry applied to an end region around the central region and adjacent to the uncoated region satisfy at least one condition selected from the group consisting of (A) to (D):
(A) the second slurry has a lower nonvolatile content than the first slurry;
(B) the second slurry has a lower tap density of the contained active material than the first slurry;
(C) the second slurry has a lower content of the binder than the first slurry; and
(D) the second slurry has a lower glass transition temperature of the contained binder than the first slurry.
<2> In the method according to <1>,
the electrode current collector may include a carbon coating layer on a surface where the coating layer is formed.
<3> In the method according to <1>,
the binder contained in the second slurry may have a glass transition temperature of −14° C. or less.
<4> In the method according to <1>,
the active material layer may have a pore volume of 0.10 mL/g or more.
<5> A method for manufacturing a power storage device includes:
welding a seal member to the electrode current collector in the uncoated region of the electrode body obtained by the method according to any one of <1> to <4>; and
forming an electrode laminate by laminating the electrode bodies to each of which the seal member is welded, and thermally welding the seal members at an end face of the electrode laminate.

The present disclosure provides the method for manufacturing the electrode body and the method for manufacturing the power storage device in which the generation of cracks at the end of the formed active material layer is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a top view illustrating a workpiece manufactured in an example.

### DETAILED DESCRIPTION OF EMBODIMENTS

Hereinafter, an embodiment which is an example of the present disclosure will be described. These descriptions and examples are illustrative of the embodiments and are not intended to limit the scope of the disclosure.

In the numerical ranges described in the present specification in a stepwise manner, the upper limit value or the lower limit value described in one numerical range may be replaced with the upper limit value or the lower limit value of the numerical range described in another stepwise manner. In addition, in the numerical range described in the present specification, the upper limit value or the lower limit value of the numerical range may be replaced with the value shown in the examples.

Each component may contain a plurality of corresponding substances. When referring to the amount of each component in a composition, when a plurality of substances corresponding to each component are present in the composition, unless otherwise specified, the total amount of the plurality of substances present in the composition is meant.

“Process” is included in this term not only as an independent process, but also as long as the desired action of the process is achieved even if it cannot be clearly distinguished from other processes.

### Method for Manufacturing Electrode Body

A method for manufacturing an electrode body according to an embodiment of the present disclosure includes the following coating step and drying step.

A slurry containing a binder, an active material, and a solvent is coated on an electrode current collector to form a coating layer. In the coating step, the slurry is applied so that an uncoated region where no slurry is applied is formed around the coating layer.

The coating layer is dried by irradiating the coating layer with a laser beam to form an active material layer.

Then, in the coating step, the first slurry applied to the central region in the coating layer (hereinafter also simply referred to as “central region”) is different from the second slurry applied to the region of the end adjacent to the uncoated region (hereinafter also simply referred to as “end region”) around the central region. The first slurry and the second slurry satisfy at least one condition selected from the group consisting of (A) to (D) below.
(A) The second slurry has a lower NV than the first slurry
(B) The tap density of the active material in which the second slurry is contained from the first slurry is low
(C) The second slurry has a lower binder content than the first slurry
(D) The second slurry has a lower glass transition temperature Tg of the binder contained in the first slurry

According to the electrode body manufacturing method of the embodiment of the present disclosure, the occurrence of cracks in the region of the end portion of the active material layer is suppressed. It is presumed that this effect is achieved for the following reasons.

Conventionally, a method of manufacturing an electrode body in which an active material layer is formed on an electrode current collector has been performed by coating a slurry containing a binder, an active material, and a solvent on the electrode current collector to form a coating layer, and then drying the coating layer. From the viewpoint of enhancing the efficiency of drying in the coating layer, drying using laser irradiation has been tried. However, when laser irradiation is performed during drying, cracks may occur at the end portions of the active material layer to be formed. The reason is considered as follows. In the drying step, the electrode current collector in the uncoated region around the coating layer is also irradiated with the laser to excessively raise the temperature of the electrode current collector, and heat is also applied to the end region of the coating layer from the electrode current collector that has been raised in temperature. Therefore, it is considered that the solvent rapidly vaporizes in the end region of the coating layer, and the generated gas cannot be removed from the coating layer, and the pressure caused by the gas is applied to cause cracks in the active material layer.

On the other hand, in the method for manufacturing an electrode body according to the embodiment of the present disclosure, the first slurry applied to the central region of the coating layer and the second slurry applied to the end region satisfy at least one condition selected from the group consisting of (A) to (D).
When the condition (A) is satisfied, NV (Nonvolatile content, non-volatile content) of the second slurry is lower than that of the first slurry, that is, the content of the solvents is higher in the second slurry in the end area. Therefore, drying is balanced with the central region, and cracking in the end region of the active material layer is suppressed.
When the condition (B) is satisfied, the tap density of the active material in which the second slurry is contained is lower than that of the first slurry, and therefore the pore volume of the active material layer to be formed is larger in the end region. As a result, the gas generated by the evaporation of the solvent is easily passed through the end region, and cracking in the end region of the active material layer is suppressed.
When the condition (C) is satisfied, the content of the binder in the second slurry is lower than that in the first slurry, and therefore the pore volume of the active material layer to be formed is larger in the end region. As a result, the gas generated by the evaporation of the solvent is easily passed through the end region, and cracking in the end region of the active material layer is suppressed.
When the condition (D) is satisfied, the glass transition temperature Tg of the binder in which the second slurry is contained is lower than that of the first slurry, and therefore, in the active material layer to be formed, the end area becomes a more flexible layer. Thus, even when pressure is applied from the gas generated by the evaporation of the solvent in the end region, the pressure is absorbed by the flexibility, and cracking in the end region of the active material layer is suppressed.

As described above, according to the method for manufacturing an electrode body according to the embodiment of the present disclosure, the occurrence of cracks in the region of the end portion of the active material layer is suppressed.

Hereinafter, a method of manufacturing an electrode body according to an embodiment of the present disclosure will be described for each step.

### Coating Process

In the coating step, a slurry containing a binder, an active material, and a solvent is coated on the electrode current collector to form a coating layer. In the coating step, the slurry is applied so that an uncoated region where no slurry is applied is formed around the coating layer.

The coating step uses a different slurry for the first slurry to be applied to the central region in the coating layer and the second slurry to be applied to the region of the end around the central region and adjacent to the uncoated region. The first slurry and the second slurry satisfy at least one condition selected from the group consisting of (A) to (D) below.

Note that the first slurry and the second slurry may satisfy two or more conditions selected from the group consisting of the following (A) to (D), and may satisfy only one condition selected from the group consisting of the following (A) to (D).

Further, the central region to which the first slurry is applied in the coating layer and the end region to which the second slurry is applied, the end region is disposed around the central region, and as long as the region adjacent to the uncoated region constitutes all the end region, the range is not particularly limited. However, the area of the end portion region is preferably 20% or less with respect to the area of the entire range of the coating layer. For example, when the coating layer has a rectangular shape, the length of the width of the end region is preferably 10% or less with respect to the length of one side of the coating layer (that is, the sum of the widths of the end regions present at both ends is preferably 20% or less with respect to the length of one side of the coating layer).

(A) the Second Slurry has a Lower NV than the First Slurry

When the second slurry has a lower NV (Nonvolatile content, non-volatile content) than the first slurry, the second slurry in the end area has a higher content of solvents. As a result, drying is balanced with the central region, and cracking in the end region of the active material layer is suppressed.

NV (non-volatile content) can be controlled by adjusting the amounts of solvents in the first slurry and the second slurry.

In the case where the condition (A) is satisfied, the binder, the active material, and the solvent included in the first slurry and the second slurry may be different in material, but each of them is preferably the same material.

NV (non-volatile content) of the first slurry is preferably, for example, greater than 74% by mass, and more preferably greater than or equal to 75% by mass. The upper limit value is preferably 80% by mass or less.

NV (non-volatile content) of the second slurry is preferably, for example, 74% by mass or less, and more preferably 73% by mass or less. The lower limit is preferably 70% by mass or more.

NV of the slurry (the first slurry and the second slurry) is determined as follows. The slurry to be measured is heated for 2 hours at a temperature of the volatilization temperature of the included solvent +20° C. Measure the mass of the slurry before and after heating. NV of the slurry (first slurry and second slurry) is calculated by the following equation: (mass after heating)/(mass before heating)×100 (mass %).

(B) The Tap Density of the Active Material in which the Second Slurry is Contained from the First Slurry is Low

Since the tap density of the active material contained in the second slurry is lower than that of the active material contained in the first slurry, the pore volume of the formed active material layer is larger in the end region. This facilitates passage of the gas generated in the end region and suppresses cracking in the end region of the active material layer.

The tap density of the active material can be controlled by adjusting the shape of the active material contained in the first slurry and the second slurry. For example, when aggregated particles (that is, secondary particles in which primary particles are aggregated) are used as the active material, the tap density can be controlled by adjusting the degree of aggregation, the number of aggregated primary particles, and the like. In the case where the condition (B) is satisfied, the binder and the solvent included in the first slurry and the second slurry may be different in material, but each of them is preferably the same material. In addition, when the condition (B) is satisfied, the active materials included in the first slurry and the second slurry may be different in material. However, it is preferable that the material is of the same type and the tap density is different (for example, the degree of aggregation is different when the aggregated particles are used).

The tap-density of the active material contained in the first slurry is preferably, for example, greater than or equal to 1.80 g/ml, and more preferably greater than or equal to 1.90 g/ml. The upper limit is preferably 2.00 g/ml or less.

The tap-density of the active material contained in the second slurry is preferably, for example, 1.80 g/ml or less, and more preferably 1.75 g/ml or less. The lower limit is preferably 1.50 g/ml or more.

The measurement of the tap density of the active material contained in the slurry (the first slurry and the second slurry) can be measured by the methods defined in JISK1469:2003 using a conventional tapping-type density measurement device.

(C) The Second Slurry has a Lower Binder Content than the First Slurry

Since the content of the binder in the second slurry is lower than that in the first slurry, the pore volume of the formed active material layer is larger in the end region. This facilitates passage of the gas generated in the end region and suppresses cracking in the end region of the active material layer.

The content of the binder can be controlled by adjusting the amount of the binder contained in the first slurry and the second slurry.

In the case where the condition (C) is satisfied, the binder, the active material, and the solvent included in the first slurry and the second slurry may be different in material, but each of them is preferably the same material.

The content of the binder in the first slurry is, for example, preferably more than 1.15% by mass, and more preferably 1.3% by mass or more. The upper limit value is preferably 1.5% by mass or less.

The content of the binder in the second slurry is preferably, for example, 1.15% by mass or less, and more preferably 1.0% by mass or less. The lower limit is preferably 0.8% by mass or more.

### (D) The Second Slurry has a Lower Glass Transition Temperature Tg of the Binder Contained in the First Slurry

The lower glass transition temperature Tg of the binder in which the second slurry is included than the first slurry results in a more flexible layer in the end regions of the formed active material layer. Accordingly, even when pressure is applied from the gas generated in the end region, the pressure is absorbed by the flexibility, and cracking in the end region of the active material layer is suppressed.

The glass transition temperature Tg of the binder can be controlled by selecting the type of binder contained in the first slurry and the second slurry. That is, when the condition (D) is satisfied, it is preferable to include binders of different materials in the first slurry and the second slurry.

When the condition (D) is satisfied, the active material and the solvent contained in the first slurry and the second slurry may be different in material, but each of them is preferably the same material.

The glass transition temperature Tg of the binder contained in the first slurry is preferably, for example, greater than −14° C., and more preferably greater than or equal to −13° C. The upper limit value is preferably −5° C. or less.

The glass transition temperature Tg of the binder contained in the second slurry is, for example, preferably −14° C. or lower, more preferably −15° C. or lower, and still more preferably −20° C. or lower. The lower limit is preferably −30° C. or higher.

The glass transition temperature Tg of the binder contained in the slurry (the first slurry and the second slurry) can be measured by differential scanning calorimetry (DSC).

In the method for manufacturing an electrode body according to the embodiment of the present disclosure, a carbon coating layer may be provided on at least the surface of the electrode current collector on which the coating layer is formed. In addition, a carbon coating layer may be provided on both surfaces. The electrode current collector having the carbon coat layer is more easily heated by laser irradiation, and as a result, cracks are likely to occur in the region of the end portion of the active material layer. However, in the method for manufacturing an electrode body according to the embodiment of the present disclosure, the first slurry applied to the central region of the coating layer and the second slurry applied to the end region satisfy at least one condition selected from the group consisting of (A) to (D). Therefore, cracking in the region of the end portion of the active material layer is suppressed.

### Drying Process

In the drying step, the coating layer is irradiated with a laser and dried to form an active material layer.

The output of the laser and the amount of heat input are not particularly limited, and are appropriately selected within a range in which the solvent in the slurry can be evaporated.

The active material layer is formed through a drying step. The active material layers preferably have a pore volume of 0.10 mL/g or more. In particular, in the end regions formed by the second slurry, the pore volume is preferably equal to or greater than 0.15 mL/g, and more preferably equal to or greater than 0.20 mL/g.

When the pore volume is within the above range, the active material layer has an appropriate gap, and the gas easily passes therethrough.

The pore volume can be adjusted by the tap density of the active material contained in the slurry, the binder content in the slurry, and the like.

Next, each component included in the slurry will be described.

### Negative Electrode Active Material Layer

Examples of the negative electrode active material include graphite-based carbon such as natural graphite, artificial graphite, and amorphous coated graphite. The proportion of graphite in the graphite-based carbon is approximately 50 mass % or more, preferably 80 mass % or more.

Examples of the binder included in the negative electrode active material include rubbers such as styrene-butadiene copolymer (SBR) and vinyl halide resins such as polyvinylidene fluoride (PVdF).

The negative electrode active material layer may further contain other components such as a thickener. Examples of the thickener include celluloses such as carboxymethyl cellulose (CMC).

### Positive Electrode Active Material Layer

Examples of the positive electrode active material include a lithium nickel-cobalt-manganese complex oxide (hereinafter, sometimes simply referred to as “LNCM”). The simplest LNCM is represented by the following general formula: LiNiₓCo_{y}Mn_{z}O₂ (where x, y, z are 0<x<1, 0<y<1, 0<z<1, x+y+z=1). In addition to Li, Ni, Co, Mn, LNCM may contain other additive elements, such as transition-metal elements other than Ni, Co, Mn, and typical metal elements other than Li. LNCM has a layered crystalline architecture. LNCM may be more than 50% by mass of the entire positive electrode active material, for example, 80 to 100% by mass. The positive electrode active material may be composed only of LNCM.

Examples of other positive electrode active materials include a lithium nickel composite oxide, a lithium cobalt composite oxide, and a lithium nickel manganese composite oxide.

Examples of the binder included in the positive electrode active material layers include vinyl halide resins such as polyvinylidene fluoride (PVdF).

The positive electrode active material layer may further contain other components such as a conductive material. Examples of the conductive material include non-graphitizable carbon, graphitizable carbon such as carbon black, and graphite.

Examples of the solvent contained in the slurry include water.

### Manufacturing Method of Power Storage Device

The electrode body obtained by the method of manufacturing the electrode body according to the embodiment of the present disclosure is used in a power storage device. The power storage device is manufactured by, for example, the following first step and second step. In the first step, the sealing member is welded to the electrode current collector in the uncoated region with respect to the electrode body. In the second step, the electrode body in which the seal member is welded is laminated to form an electrode body, and the seal members on the end face of the electrode body are thermally welded to each other.

The power storage device obtained by the method of manufacturing the power storage device according to the embodiment of the present disclosure is preferably used in, for example, a lithium ion battery. The battery includes, for example, a negative electrode, a positive electrode, a separator, and an electrolyte. The power storage device may be a solid battery having a solid electrolyte or a liquid battery having a liquid electrolyte solution, but a liquid battery is preferable. In addition, a bipolar battery including a positive electrode active material layer and a negative electrode active material layer on both surfaces of a current collector having functions of a positive electrode current collector and a negative electrode current collector may be used. The positive electrode includes, for example, a positive electrode current collector and a positive electrode active material layer fixed on the positive electrode current collector. The negative electrode includes, for example, a negative electrode current collector and a negative electrode active material layer fixed on the negative electrode current collector. The separator is an electrically insulating porous film. The separator electrically isolates the positive electrode and the negative electrode. The battery according to the embodiment of the present disclosure may further be a liquid-based battery having an electrolytic solution. In particular, a non-aqueous electrolyte solution is preferable.

Applications of batteries include, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Experimental Method

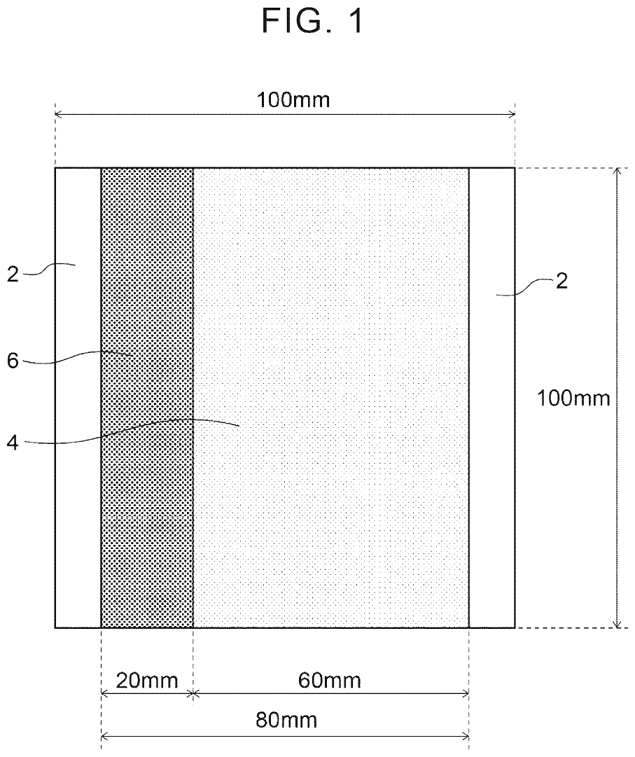

As shown in FIG. 1, with respect to the rectangular electrode foil 2 of one side is 100 mm, an area of 80 mm in the center was used as the coating region of the slurry, leaving 10 mm at each end (i.e., as the uncoated region). Specifically, the range of 60 mm of one end side of the coating region (right side in FIG. 1) was the first slurry region 4 for applying the slurry 1, the range of 20 mm of the other end side (left side in FIG. 1) was the second slurry region 6 for applying the slurry 2. In each of Examples and Comparative Examples, the slurry 1 shown in Table 1 was applied to the first slurry region 4 of the electrode foil 2, and the slurry 2 shown in Table 2 was applied to the second slurry region 6 to prepare a workpiece.

The workpiece was irradiated with lasers (i.e., whole-surface irradiation) in the same irradiation area as the size of the workpiece (i.e., 100 mm×100 mm), and the slurry of the workpiece was dried. For each of the workpieces of Examples and Comparative Examples, increasing the output of the laser to be irradiated (that is, shortening the time required for drying to be completed) and the limit time (seconds) that can be dried without cracking was measured for each of the first slurry region 4 coated with the slurry 1 and the second slurry region 6 coated with the slurry 2.

Results for each of the first slurry region and the second slurry region are shown in Table 1 and Table 2. The shorter the limit time, the less cracks are generated.

TABLE 1

| | | Slurry 1 | | | | | | Crack |
|---|---|---|---|---|---|---|---|---|
| | | | | | | | Electrode | limit |
| | | | Slurry | | Binder | | body | time |
| | Collector | Tap | NV | | content | Binder | pore | Slurry |
| | foil | density | mass | Binder | mass | Tg | volume | 1 |
| | type | g/ml | % | species | % | ° C. | mL/g | Second |
| Comparative | Carbon | 1.9 | 75 | SBR | 1.3 | −13 | 0.13 | 80 |
| Example 1 | coated | | | | | | | |
| Example 1 | Al foil | | | | | | | 90 |
| Example 2 | | | | | | | | 90 |
| Example 3 | | | | | | | | 90 |
| Example 4 | | | | | | | | 90 |
| Example 5 | | | | | | | | 90 |

TABLE 2

| | | Slurry 2 | | | | | | Crack |
|---|---|---|---|---|---|---|---|---|
| | | | | | | | Electrode | limit |
| | | | Slurry | | Binder | | body | time |
| | Collector | Tap | NV | | content | Binder | pore | Slurry |
| | foil | density | mass | Binder | mass | Tg | volume | 2 |
| | type | g/ml | % | species | % | ° C. | mL/g | Second |
| Comparative | Carbon | 1.9 | 75 | SBR | 1.3 | −10 | 0.10 | 80 |
| example 1 | coated | | | | | | | |
| Example 1 | Al foil | 1.9 | 72 | SBR | 1.3 | −10 | 0.10 | 75 |
| Example 2 | | 1.9 | 75 | SBR | 1.0 | −10 | 0.25 | 70 |
| Example 3 | | 1.75 | 75 | SBR | 1.3 | −10 | 0.18 | 65 |
| Example 4 | | 1.9 | 75 | SBR | 1.3 | −15 | 0.10 | 70 |
| Example 5 | | 1.9 | 75 | SBR | 1.3 | −22 | 0.10 | 60 |

From the results shown in Table 2, in Comparative Example 1, cracks occurred by overheating due to electric heating from the current collector foil side to the second slurry region.

In Example 1, the slurry 2 having a lower NV than that of the slurry 1 was used, and cracking at the end portion was suppressed as compared with Comparative Example 1.

In Example 2, the slurry 2 having a binder content lower than that of the slurry 1 was used, and cracking at the end portion was suppressed as compared with Comparative Example 1.

In Example 3, the slurry 2 containing an active material having a tap density lower than that of the slurry 1 was used, and cracking at the end portion was suppressed as compared with Comparative Example 1.

In Examples 4 and 5, the slurry 2 containing a binder having a lower Tg than that of the slurry 1 was used, cracking at the end portion as compared with Comparative Example 1 could be suppressed.

What is claimed is:

1. A method of manufacturing an electrode body, the method comprising:
applying a slurry containing a binder, an active material, and a solvent to an electrode current collector to form a coating layer and to form an uncoated region where the slurry is not applied on a periphery of the coating layer; and
drying the coating layer by irradiating the coating layer with a laser to form an active material layer, wherein in the applying, a first slurry applied to a central region of the coating layer and a second slurry applied to an end region around the central region and adjacent to the uncoated region satisfy at least one condition selected from the group consisting of (A) to (D):
(A) the second slurry has a lower nonvolatile content than the first slurry;
(B) the second slurry has a lower tap density of the contained active material than the first slurry;
(C) the second slurry has a lower content of the binder than the first slurry; and
(D) the second slurry has a lower glass transition temperature of the contained binder than the first slurry.

2. The method according to claim 1, wherein the electrode current collector includes a carbon coating layer on a surface where the coating layer is formed.

3. The method according to claim 1, wherein the binder contained in the second slurry has a glass transition temperature of −14° C. or less.

4. The method according to claim 1, wherein the active material layer has a pore volume of 0.10 mL/g or more.

5. A method of manufacturing a power storage device, the method comprising:
welding a seal member to the electrode current collector in the uncoated region of the electrode body obtained by the method according to claim 1; and
forming an electrode laminate by laminating the electrode bodies to each of which the seal member is welded, and thermally welding the seal members at an end face of the electrode laminate.
